(19) United States
(12) Patent Application Publication
(10) Pub. No.: US 2026/0315680 A1
(43) Pub. Date: Oct. 15, 2026

(54) CHEST DRAIN SECUREMENT DEVICES

(71) Applicant: OSF Healthcare System, Peoria, IL (US)

(72) Inventors: Bradley D. HAYES, Belvidere, IL (US); Eric P. BERGSTROM, Grand Haven, MI (US)

(21) Appl. No.: 19/630,906

(22) Filed: Mar. 27, 2026

Related U.S. Application Data
(60) Provisional application No. 63/789,245, filed on Apr. 15, 2025.

(51) Int. Cl. A61M 1/00

(52) U.S. Cl. CPC A61M 1/84

(57) ABSTRACT

Chest drain securement devices are disclosed that in some examples include a medial structure coupled on opposing sides to first and second supports having a height in a first plane substantially perpendicular to a long axis of the medial structure. The medial structure and the supports collectively define an opening configured to receive a portion of a floor stand of a chest drain. First and second bases extend from the first and second supports and comprise first and second bottom surfaces that are substantially flat and in a second plane perpendicular to the first plane. First and second adhesives include adhesive layer(s) and have an upper surface configured to attach to the first and second bottom surfaces and a lower surface configured to attach to an external flat surface. The upper and lower surfaces may have different adhesive properties.

This application claims the benefit of U.S. Provisional Patent Application No. 63/789,245, filed on Apr. 15, 2025, which is incorporated herein by reference in its entirety

### BACKGROUND

Nurses and other medical professionals face significant challenges with the use of chest drains with patients, including ensuring the tube coupled to the chest drain remains in place, preventing the chest drain from tipping over, and managing the accuracy of fluid measurements. In particular, there are no existing devices that effectively stabilize a chest drain to maintain its position and prevent accidental tipping, dislodgment, or displacement, which can lead to stress, potential errors in patient care, and increased risk of patient harm.

Existing solutions for chest drain securement include the use of a built-in base or pedestal to increase stability of the cheat drain on a flat surface. Referring to FIG. 1, an exemplary prior art chest drain 100 is illustrated. In this example, the chest drain 100 includes a floor stand 102 that is rotatable to increase the stability of the chest drain 100 when placed on a flat surface, such as a floor proximate a patient’s hospital bed, for example. However, the floor stand 102 present on the existing chest drain 100 is insufficient and susceptible to fail in response to minimal force, particularly towards the top of the chest drain 100 (e.g., from inadvertent contact with a caregiver or patient).

Other health care facilities rely on ad hoc methods to increase chest drain stability, such as taping the chest drain to a flat surface. Although this adherence method offers a temporary solution, it remains susceptible to displacement when subjected to external forces. Moreover, adhering the chest drain to a floor takes time, is not a reusable solution, leaves residue, and generally must be repeated for ambulatory patients when the chest drain is moved with the patient. Other solutions such as tying or strapping the chest drain to an intravenous (IV) tower, pole, or stand are even less stable and are more likely to yield inaccurate fluid level measurements.

### BRIEF DESCRIPTION OF THE DRAWINGS

FIG. 1 is a perspective view of an exemplary prior art chest drain with a rotatable floor stand;

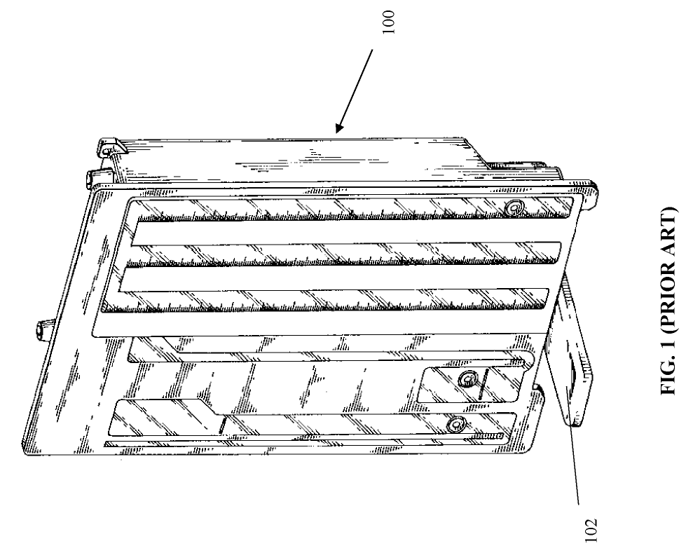

FIG. 2 is a front, top, perspective view of a chest drain securement device in accordance with some examples of the disclosed technology;

FIG. 3 is a front, bottom, perspective view of the exemplary chest drain securement device of FIG. 2; and

FIG. 4 is a table illustrating exemplary formulations of a base acrylic PSA chemistry that could be used to secure the exemplary chest drain securement device of FIG. 2 in some examples of the disclosed technology.

### DETAILED DESCRIPTION

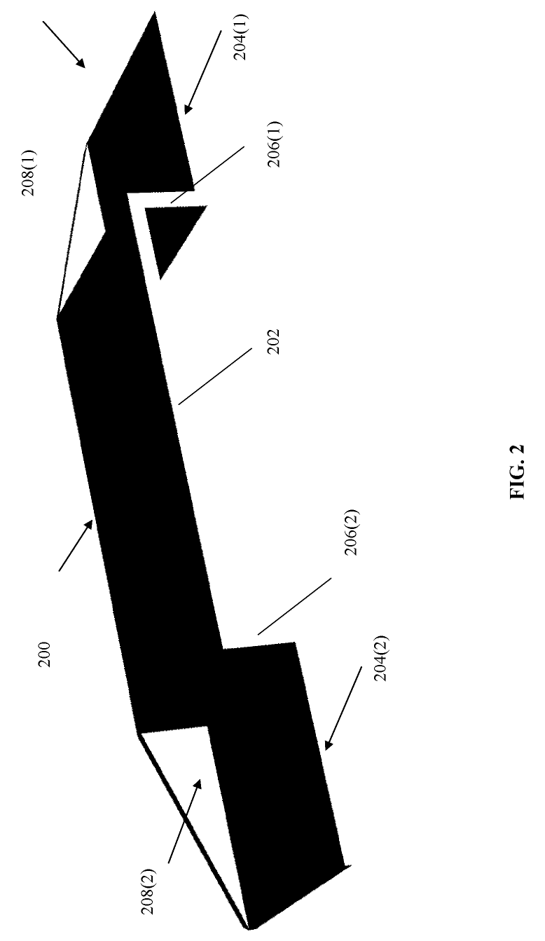

Referring to FIG. 2, a front, top, perspective view of a chest drain securement device 200 in accordance with some examples of the disclosed technology is illustrated. The exemplary chest drain securement device 200 is advantageously configured to secure and stabilize any chest drain 100 with a pedestal, floor stand, leg, or other protruding structure (commonly referred to herein as a floor stand 102) that may be coupled to the chest drain 100 to reduce tip over risk. Exemplary chest drains with which the disclosed technology may be utilized include the Atrium Oasis^{TM} dry suction water seal chest drain, Atrium Ocean^{TM} wet suction water seal chest drain, or Atrium Express^{TM} dry seal chest drain available from Getinge AB of Gothenburg, Sweden, the Vide Shore^{TM}, Vide Wave^{TM}, or Vide Sand^{TM} available from Front1 Health Partners of Bloomington, Illinois, or the Sahara^{TM} series (e.g., S-1100-08LF, S-1200-08LF, S-1102-08LF, S-1150-08:F, S-1130-08LF, or S-0500), Cactus^{TM} series (e.g., A-6000-08LF, A-6002-08LF, A-6020-08LF, A-6050-08LF, or A-9250LF), or Rain^{TM} series (e.g., A-7000-08LF, A-7002-08LF, or A-7050-08LF) available from Teleflex Incorporated of Wayne, Pennsylvania, although the disclosed technology can be used with any other chest drain that include a floor stand in other examples.

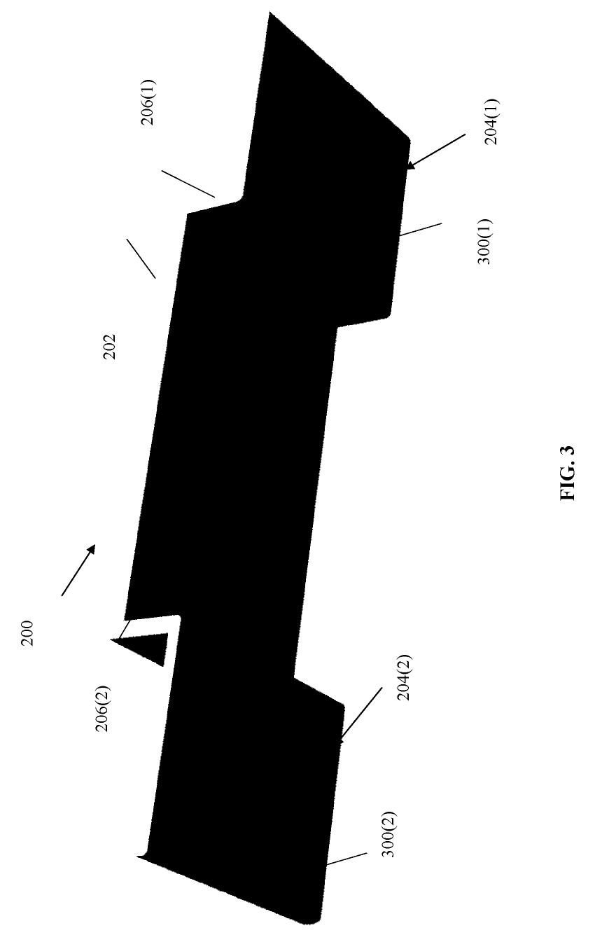

The chest drain securement device 200 in this example includes a medial structure 202 and first and second bases 204(1) and 204(2) coupled to opposing sides of the medial structure 202 by first and second supports 206(1) and 206(2), respectively. The first and second bases 204(1) and 204(2) in this example have a substantially flat bottom surface (illustrated in FIG. 3) for contact with a flat surface, such as a floor of a patient room. While the first and second bases 204(1) and 204(2) are illustrated in FIG. 2 as having a substantially square shape, one or both of the first and/or second base 204(1) and/or 204(2) can be rectangular or any other shape in other examples.

The first and second supports 206(1) and 206(2) extend vertically from interior portions of the first and second bases 204(1) and 204(2), respectively, and are therefore coupled at lower ends to the first and second bases 204(1) and 204(2) and at upper ends to the medial structure 202. While the first and second supports 206(1)-206(2) extend perpendicularly upward from the first and second bases 204(1) and 204(2) and downward from the medial structure 202, other angles can also be used for any of the support intersections with other components of the chest drain securement device 200.

Thus, the medial structure 202 is disposed higher than the first and second bases 204(1) and 204(2) and is sized and configured to receive at least a portion of a floor stand 102 of a chest drain 100 when placed above or on top of the floor stand 102. Accordingly, the first and second supports 206(1) and 206(2) and the medial structure 202 collectively define an opening or recess that is sufficiently long (or wide as the case may be depending on the shape of the floor stand 102) and high to receive a floor stand 102 of a chest drain 100 to be secured by the chest drain securement device 200.

The height of the first and second supports 206(1) and 206(2) (i.e., in the direction of the short axes of the first and second supports 206(1) and 206(2) as illustrated in FIG. 2) in some examples is also sufficiently small such that the medial structure 202 does not block visibility of any markings on the chest drain 100 when the chest drain securement device 200 is placed on top of the floor stand 102 of the chest drain 100.

When the medial structure 202 is placed on top of the floor stand 102, the first and second supports 206(1) and 206(2) are disposed on opposing sides of the floor stand 102, and the first and/or second bases 204(1) and/or 204(2) are attached to a flat surface (e.g., a floor), as explained in more detail below, the floor stand 102 is substantially prevented from moving upward, thereby preventing the chest drain 100, to which the floor stand 102 is connected, from tipping over.

While the medial structure 202 is illustrated in FIG. 2 as having a substantially flat upper surface, and as being substantially rectangular in shape, other shapes and/or non-uniform surfaces can also be used so long as at least a portion of a lower surface of the medial structure 202 is configured to be disposed proximate an upper surface of the floor stand 102 of the chest drain 100 to substantially prevent tipping of the floor stand 102 and chest drain 100 coupled thereto. For example, if the floor stand 102 has a substantially convex upper surface, the medial structure 202, and/or a bottom surface thereof, may have a corresponding concave shape, and other shapes and permutations can also be used in yet other examples.

In this example, the chest drain securement device 200 also includes optional first and second flanges 208(1) and 208(2) having sides that are adjacent to the first and second bases 204(1) and 204(2) and the first and second supports 206(1) and 206(2), respectively. Thus, the first and second flanges 208(1)-208(2) are substantially triangular in shape in this example, although any other shape can also be used in other examples.

The first and second flanges 208(1)-208(2) add support to the overall chest drain securement device 200 and can be disposed adjacent a front surface of the chest drain 100 when the chest drain securement device 200 is placed on top of a floor stand 102 of the chest drain 100. While the first and second flanges 208(1)-208(2) have a side corresponding in length to a width of the first and second bases 204(1) and 204(2) (i.e., in the direction of the long axis of the medial structure 202), respectively, and another side corresponding in height (i.e., in the direction of the short axes of the first and second supports 206(1) and 206(2)) to that of the first and second supports 206(1) and 206(2), respectively, other dimensions can also be used in other examples.

Similarly, the first and second bases 204(1) and 204(2) have a side having a length (i.e., in the direction of the long axis of the first and second supports 206(1) and 206(2)) corresponding to that of the first and second supports 206(1) and 206(2), respectively, and corresponding to a width of the medial structure 202 (i.e., in the direction of the short axis of the medial structure 202), although other dimensions for the first and second bases 204(1) and 204(2) can also be used in other examples.

Further, the first and second supports 206(1) and 206(2) have a side having a length (i.e., in the direction of the long axes of the first and second supports 206(1) and 206(2)) corresponding that of the first and second bases 204(1) and 204(2), respectively, and another side having another length (i.e., the same length in this example and in the direction of the direction of the long axes of the first and second supports 206(1) and 206(2)) corresponding to a width of the medial structure 202 (i.e., in the direction of the short axis of the medial structure 202), although other dimensions for the first and second supports 206(1) and 206(2) (and/or the medial structure 202) can also be used in yet other examples.

Thus, the shapes and sizes (e.g., width, height, length, and/nor thickness) of the components (e.g., bases 204(1) and 204(2), supports 206(1) and 206(2), medial structure 202, and/or flanges 208(1) and 208(2)) of the chest drain securement device 200 are illustrated in FIG. 2 for exemplary purposes only and other shapes and/or sizes can also be used in other examples for any of those components. Further, the exemplary chest drain securement device 200 illustrated in FIG. 2 is a monolithic structure, although any of the components can be separately manufactured and/or coupled or attached to any of the other components in other examples. In some examples, the chest drain securement device 200 is made of a thermoplastic polymer material (e.g., acrylonitrile butadiene styrene (ABS)) but metallic and other materials, and/or combinations thereof, can also be used in other examples.

Referring now to FIG. 3, a front, bottom, perspective view of the chest drain securement device 200 of FIG. 2 in accordance with some examples of the disclosed technology is illustrated. In this example, the first and second bases 204(1) and 204(2) include first and second bottom surfaces 300(1) and 300(2), respectively, to which an attachment mechanism is attached. The attachment mechanism(s) can include a hook-and-loop system (e.g., Velcro^{TM}), a suction, or any other system for facilitating attachment of the chest drain securement device 200 to a flat external surface (e.g., a floor). The attachment mechanism attached to the first bottom surface 3001(1) can be the same or different than another attachment mechanism attached to the second bottom surface 300(2).

In some examples, the attachment mechanism includes one or more layers of adhesive (not shown) applied to each of the first and second bottom surfaces 300(1) and 300(2) (the adhesive layer(s) collectively referred to herein as the adhesive). The thickness of the adhesive can impact the overall height of the chest drain securement device 200 such that a thicker adhesive may require a smaller height of the first and second supports 206(1) and 206(2) (i.e., in the direction of the short axes of the first and second supports 206(1) and 206(2)), for example, and vice versa. The adhesive generally maintains the chest drain securement device 200 in place as attached to a flat surface (e.g., a floor), thereby stabilizing or securing the floor stand 102, and the chest drain 100 coupled thereto, when the floor stand 102 is received by the opening formed by the medial structure 202 and the first and second supports 206(1) and 206(2).

In some examples, the adhesive can have a double-sided tape construction utilizing acrylic pressure-sensitive adhesives (PSAs) including one on an upper side that forms a strong, relatively permanent bond to the first and second bottom surfaces 300(1) and 300(2) of the chest drain securement device 200, and another on the opposite, lower side that can form a strong, yet repositionable, bond to common medical facility flooring materials, such as laminate tile or textured wood laminate, for example. PSAs in some examples are composed of a blend of different acrylic monomers to achieve a desired balance of properties (e.g., tack, peel adhesion, and/or shear strength). These acrylic monomers are generally categorized into soft monomers (having relatively low glass transition temperature, hard monomers (having relatively high glass transition temperature), functional monomers (also referred to as polar monomers), and other monomers useful for specific properties.

Soft monomers (e.g., 2-Ethylhexyl Acrylate (2-EHA), n-Butyl Acrylate (BA), Ethyl Acrylate (EA), and Iso-octyl Acrylate (IOA)) provide the adhesive with its inherent tackiness and flexibility, allowing it to wet the surface and form an initial bond under light pressure. Hard monomers (e.g., Methyl Methacrylate (MMA), Methyl Acrylate (MA), Vinyl Acetate (VAM), and Styrene) contribute to the cohesive strength (i.e., internal strength) and stiffness of the adhesive, providing resistance to shear forces and preventing the adhesive from tearing or leaving residue upon removal. Functional monomers (e.g., Acrylic Acid (AA), Methacrylic Acid (MAA), 2-Hydroxyethyl Acrylate (HEA), and N-Vinyl Pyrrolidone (NVP)) contain functional groups (e.g., carboxylic acid, hydroxyl) that enhance specific adhesion to certain substrates, improve cohesion through hydrogen bonding or crosslinking, and can provide sites for chemical crosslinking. Other Monomers that can be used in acrylic PSAs for specific properties include Diacetone Acrylamide (DAAM) (for crosslinking), Vinyl Trimethoxysilane (for adhesion to specific surfaces), and Caprolactone-modified (Meth)acrylates (for improved durability and flexibility).

In some examples, the adhesive (i.e., comprising any number of adhesive layers) applied to the first and/or second bottom surface 300(1) and/or 300(2) of the first and/or second bases 204(1) and/or 204(2), respectively, is formed by using a single base acrylic PSA chemistry, and varying one or more of the cross-linking density during the curing process and/or the coating thickness applied to each side of the carrier film, to achieve differential adhesion profiles on opposing sides and/or at opposing upper and lower surfaces of the adhesive.

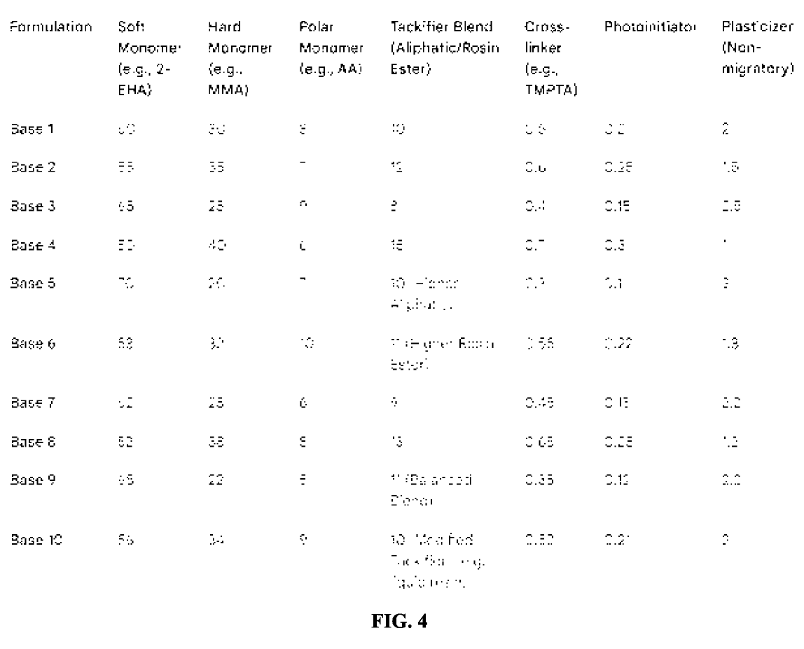

Referring to FIG. 4, exemplary formulations of a base acrylic PSA chemistry that could be used for one or more of the adhesive layer(s) applied to the first and/or second bottom surface 300(1) and/or 300(2) of the first and/or second bases 204(1) and/or 204(2), respectively, is illustrated. In addition to a monomer base, other components of the adhesive can include a tackifier blend, cross-linker, photo-initiator, and/or plasticizer, for example, as illustrated in FIG. 4. Thus, a desired degree of permanent or durable adhesion on one side of the adhesive, and of residue-free, high-tack repositionability on the opposing side of the adhesive, can be accomplished via optimization of the base formulation or chemistry and/or the processing parameters (i.e., differential processing techniques).

Accordingly, in some examples, the adhesive can include a PSA monomer, such as acrylic, natural rubber, synthetic rubber, vinyl ether, or silicone monomers. In other examples, hot melt PSAs can be used for one or more layers of the adhesive, including styrenic block copolymers, elastomeric polymers, acrylics, polyolefins silicones. In yet other examples, water-based PSAs can be used.

Optionally, a double-sided adhesive with disparate adhesion requirements (e.g., near permanent to plastic, removable/repositionable to laminate) can be designed using differential adhesive chemistry and a carrier with specific properties. For example, different PSA chemistries can be used in each side of a carrier film of the adhesive. On a first side, a solvent-based or potentially a UV-cured hot melt acrylic PSA for a permanent bond to injection molded plastic and, on a second side, a water-based acrylic PSA or a low-tack silicone PSA can be used for a removable/repositionable bond to laminate flooring.

In these examples, PET (Polyester) or a high-strength polypropylene film can be used for the carrier film due to their tensile strength and resistance to tearing, although other types of carrier films could also be used in other examples. Optionally, the adhesive can be treated with different release coatings on each side of the carrier film to facilitate the application and performance of the different adhesives. Thus, the adhesive in some examples is a multi-layer system including a layer for high adhesion and shear, combined with a release layer and another adhesive for repositionability, although other types of structures can also be used.

With this technology, chest drains can be advantageously secured or stabilized to flat surfaces, such as a floor of a medical facility and proximate a patient. The chest drain securement devices of this technology are repositionable without leaving significant residue, attached quickly, maintain visibility of chest drain fluid levels, and facilitate re-securement of chest drains for ambulatory patients without having to be re-secured to a flat surface. Accordingly, this technology reduces accidental tip over of chest drains and associated issues for medical professionals managing accuracy of fluid level measurements for patients.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A chest drain securement device, comprising:
a medial structure coupled on opposing sides to first and second supports each having a height in a first plane substantially perpendicular to a long axis of the medial structure, wherein the medial structure and the first and second supports collectively define an opening configured to receive at least a portion of a floor stand of a chest drain;
first and second bases extending from the first and second supports, respectively, wherein the first and second bases comprise first and second bottom surfaces, respectively, and the first and second bottom surfaces are substantially flat and in a second plane perpendicular to the first plane; and
first and second attachment mechanisms each having an upper surface configured to attach to one of the first or second bottom surface and a lower surface configured to couple the chest drain securement device to an external flat surface.

2. The chest drain securement device of claim 1, wherein the first and second attachment mechanisms comprise first and second adhesives, respectively, each comprising one or more adhesive layers, and the lower surface of each of the first and second adhesives is configured to attach to the external flat surface.

3. The chest drain securement device of claim 2, wherein:
the upper and lower surfaces comprise upper and lower adhesive layers, respectively, coupled together via a carrier film and the upper adhesive layer has one or more different adhesive properties than the lower adhesive layer; and
the upper adhesive layer is configured to form a stronger bond to a thermoplastic than the lower adhesive layer is configured to form to a laminate flooring material.

4. The chest drain securement device of claim 1, wherein the first and second bases extend perpendicularly from the first and second supports, respectively.

5. The chest drain securement device of claim 1, further comprising first and second flanges each having first and second sides disposed adjacent to the first and second bases and the first and second supports, respectively.

6. The chest drain securement device of claim 1, further comprising a monolithic thermoplastic polymer material structure.

7. A chest drain securement kit, comprising:
a chest drain securement device, comprising:
a medial structure coupled on opposing sides to first and second supports each having a height in a first plane substantially perpendicular to a long axis of the medial structure; and
first and second bases extending from the first and second supports, respectively, wherein the first and second bases comprise first and second bottom surfaces, respectively, and the first and second bottom surfaces are substantially flat and in a second plane perpendicular to the first plane; and
at least two adhesive systems each comprising a carrier film, an upper adhesive material disposed on a first side of the carrier film, and a lower adhesive material different than the upper adhesive material and disposed on a second side of the carrier film.

8. The chest drain securement kit of claim 7, wherein the upper adhesive material of each of the at least two adhesive systems is configured to attached to one of the first or second bottom surfaces and the lower adhesive material of each of the at least two adhesive systems is configured to attached to an external flat surface.

9. The chest drain securement kit of claim 7, wherein the medial structure and the first and second supports collectively define an opening configured to receive at least a portion of a floor stand of a chest drain.

10. The chest drain securement kit of claim 7, wherein the chest drain securement device further comprises first and second flanges each having first and second sides disposed adjacent to the first and second bases and the first and second supports, respectively.

11. A chest drain system, comprising:
a chest drain comprising a floor stand; and
a chest drain securement device, comprising:
a medial structure coupled on opposing sides to first and second supports each having a height in a first plane substantially perpendicular to a long axis of the medial structure, wherein the medial structure and the first and second supports collectively define an opening configured to receive at least a portion of the floor stand;
first and second bases extending from the first and second supports, respectively, wherein the first and second bases comprise first and second bottom surfaces, respectively, and the first and second bottom surfaces are substantially flat and in a second plane perpendicular to the first plane; and
first and second adhesives comprising one or more adhesive layers and having an upper surface configured to attach to the first and second bottom surfaces, respectively, and a lower surface configured to attach to an external flat surface.

12. The chest drain system of claim 11, wherein the upper and lower surfaces comprise upper and lower adhesive layers, respectively, coupled together via a carrier film and the upper adhesive layer has one or more different adhesive properties than the lower adhesive layer.

13. The chest drain system of claim 12, wherein the chest drain securement device further comprises a monolithic structure comprises a thermoplastic polymer material and the upper adhesive layer is configured to form a stronger bond to the thermoplastic polymer material than the lower adhesive layer is configured to form to a laminate flooring material.

14. The chest drain system of claim 11, wherein the first and second bases extend perpendicularly from the first and second supports, respectively.

15. The chest drain system of claim 11, wherein the chest drain securement device further comprises first and second flanges each having first and second sides disposed adjacent to the first and second bases and the first and second supports, respectively.
